(19) United States
(12) Patent Application Publication
(10) Pub. No.: US 2018/0095278 A1
(43) Pub. Date: Apr. 5, 2018

(54) TECHNIQUES FOR IMAGE PROJECTION

(71) Applicant: INTEL CORPORATION, Santa Clara, CA (US)

(72) Inventor: JONATHAN MASSON, PULLY (CN)

(73) Assignee: INTEL CORPORATION, Santa Clara, CA (US)

(21) Appl. No.: 15/283,316

(22) Filed: Oct. 1, 2016

(51) Int. Cl. G02B 27/01; G02B 26/08; G02B 27/42

(52) U.S. Cl. CPC G02B 27/0172; G02B 26/0833; G02B 27/4227; G02B 2027/0127; G02B 2027/0178; G02B 2027/011; G02B 2027/0174

(57) ABSTRACT

Various embodiments are generally directed to techniques for image projection, such as in a computer-mediated reality system, for instance. Some embodiments are particularly directed to a computer-mediated reality system that is able to create an eyebox array for viewing images or sequences of images (e.g. video), the eyebox array created by reflecting projected images with a field imaging display. In some embodiments, the computer-mediated reality system may include a wearable frame, such as eyeglasses, to enable a user to utilize the computer-mediated reality system. For instance, the wearable frame may position the field imaging display such that different eyeboxes in the eyebox array come into focus as the user shifts their eyes between different directions of gaze.

### BACKGROUND

A projector can be an optical device that projects an image onto a surface, such as a projection screen. Typically, projectors create an image by shining a light through a transparent lens. A projector may be used in computer-mediated reality systems. Generally, computer-mediated reality refers to the ability to add to, subtract information from, or otherwise manipulate a user's perception of reality through the use of a computer, such as a wearable computer or a hand-held device.

### BRIEF DESCRIPTION OF THE DRAWINGS

FIG. 1A illustrates an embodiment of a computer-mediated reality system.

FIG. 1B illustrates an embodiment of a computer-mediated reality system in conjunction with an eye.

FIG. 1C illustrates an embodiment of a wearable frame.

FIG. 2 illustrates a block diagram of an embodiment of a computer-mediated reality system.

FIG. 3 illustrates an embodiment of a projector in conjunction with a projected image.

FIG. 4 illustrates an embodiment of a reflected image array.

FIG. 5A illustrates a first arrangement to record a light field in a HOE.

FIG. 5B illustrates a second arrangement to record a light field in a HOE.

FIG. 6 illustrates an embodiment of a first logic flow.

FIG. 7 illustrates an embodiment of a second logic flow.

FIG. 8 illustrates an embodiment of a storage medium.

FIG. 9 illustrates an embodiment of a computing architecture.

FIG. 10 illustrates an embodiment of a communication architecture.

### DETAILED DESCRIPTION

Various embodiments are generally directed to techniques for image projection, such as in a computer-mediated reality system, for instance. Some embodiments are particularly directed to a computer-mediated reality system that is able to create an eyebox array for viewing images or sequences of images (e.g. video), the eyebox array created by reflecting projected images with a field imaging display. In some embodiments, the computer-mediated reality system may include a wearable frame, such as eyeglasses, to enable a user to utilize the computer-mediated reality system. For instance, the wearable frame may position the field imaging display such that different eyeboxes in the eyebox array come into focus as the user shifts their eyes between different directions of gaze. Various embodiments described herein may include a projector to project images onto a holographic optical element (HOE) of the field imaging display, the HOE to provide a predefined optical function that reflects the projected image in a manner that creates the eyebox array for viewing images or sequences of images. For instance, the projector may include a scanning mirror and a light source that can project images onto the HOE and a light field recorded in the HOE may reflect the projected image towards an eye of a user to create the eyebox array.

Some challenges facing computer-mediated reality systems include impractical, bulky, and inefficient techniques for creating an image. Computer-mediated reality systems can require the use of combining prisms, flat waveguide combining optics, and/or panel displays to create an image, resulting in an unnecessarily large and heavy device with several performance limitations. These performance limitations can result in a tradeoff between projector size, eyebox size, field of view (FOV), and resolution. For example, panel displays may need to be located within the line of sight of a user, reducing the FOV by being opaque and leading to a tradeoff between resolution and the FOV. Further, requiring flat waveguide combining optics may prevent the computer-mediated reality system from utilizing curved lenses in a wearable frame, preventing the computer-mediated reality system from having desirable aesthetics. These and other factors may result in a computer-mediated reality system with poor performance and limited adaptability. Such limitations can drastically reduce the usability and applicability of the computer-mediated reality system, contributing to inefficient systems with reduced capabilities.

Various embodiments described herein include a computer-mediated reality system with a projector and a field imaging display to efficiently and effectively provide a computer-mediated reality to a user. The projector and the field imaging may enable the computer-mediated reality system to provide full color images with large eyeboxes in an efficient, light-weight, and aesthetically desirable manner. For instance, the projector may be ultra-compact and able to provide full color images with a large field of view (FOV) while being light-weight and energy efficient. Further, the field imaging display may be transparent and/or have a curved geometry. In these and other ways the computer-mediated reality system may enable flexible and efficient computer-mediated reality to achieve better performing, desirable, and more dynamic computer-mediated reality systems, resulting in several technical effects and advantages.

In various embodiments, the computer-mediated reality system may include a projector, a field imaging display, and a wearable frame. The projector may include a light source and be able to project an image. The field imaging display may include a holographic optical element (HOE) with a light field recorded therein. The light field recorded in the HOE may provide a predefined optical function when the projector projects the image on the HOE. The wearable frame may couple to the projector and the field imaging display and hold the projector in a certain position with respect to the field imaging display.

With general reference to notations and nomenclature used herein, one or more portions of the detailed description which follows may be presented in terms of program procedures executed on a computer or network of computers. These procedural descriptions and representations are used by those skilled in the art to most effectively convey the substances of their work to others skilled in the art. A procedure is here, and generally, conceived to be a self-consistent sequence of operations leading to a desired result. These operations are those requiring physical manipulations of physical quantities. Usually, though not necessarily, these quantities take the form of electrical, magnetic, or optical signals capable of being stored, transferred, combined, compared, and otherwise manipulated. It proves convenient at times, principally for reasons of common usage, to refer to these signals as bits, values, elements, symbols, characters, terms, numbers, or the like. It should be noted, however, that all of these and similar terms are to be associated with the appropriate physical quantities and are merely convenient labels applied to those quantities.

Further, these manipulations are often referred to in terms, such as adding or comparing, which are commonly associated with mental operations performed by a human operator. However, no such capability of a human operator is necessary, or desirable in most cases, in any of the operations described herein that form part of one or more embodiments. Rather, these operations are machine operations. Useful machines for performing operations of various embodiments include general purpose digital computers as selectively activated or configured by a computer program stored within that is written in accordance with the teachings herein, and/or include apparatus specially constructed for the required purpose. Various embodiments also relate to apparatus or systems for performing these operations. These apparatuses may be specially constructed for the required purpose or may include a general-purpose computer. The required structure for a variety of these machines will be apparent from the description given.

Reference is now made to the drawings, wherein like reference numerals are used to refer to like elements throughout. In the following description, for purpose of explanation, numerous specific details are set forth in order to provide a thorough understanding thereof. It may be evident, however, that the novel embodiments can be practiced without these specific details. In other instances, well known structures and devices are shown in block diagram form in order to facilitate a description thereof. The intention is to cover all modification, equivalents, and alternatives within the scope of the claims.

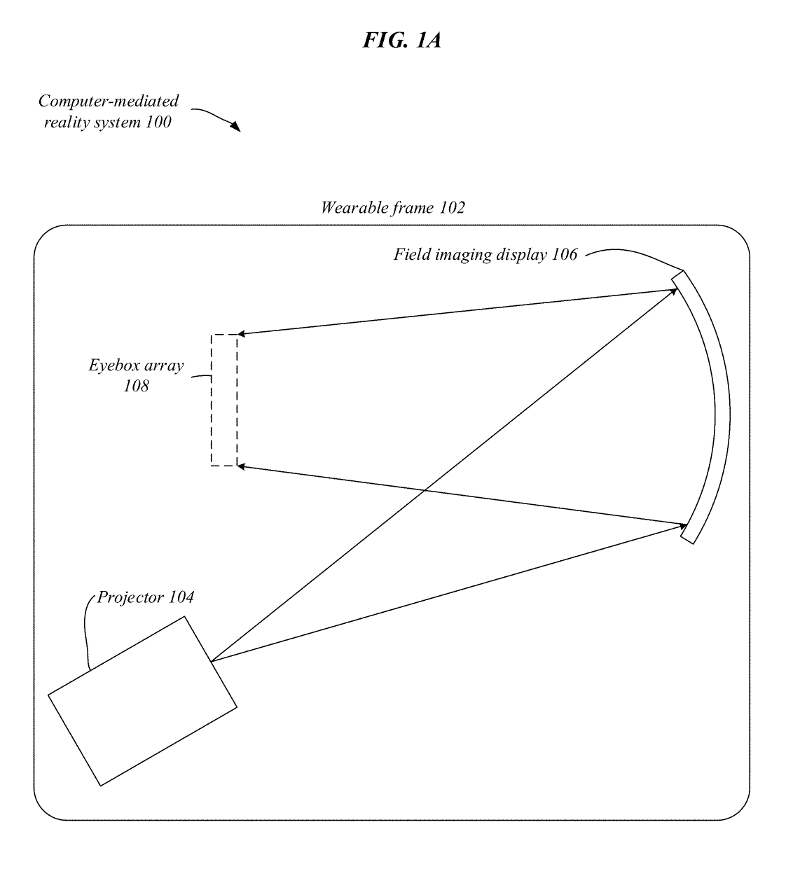

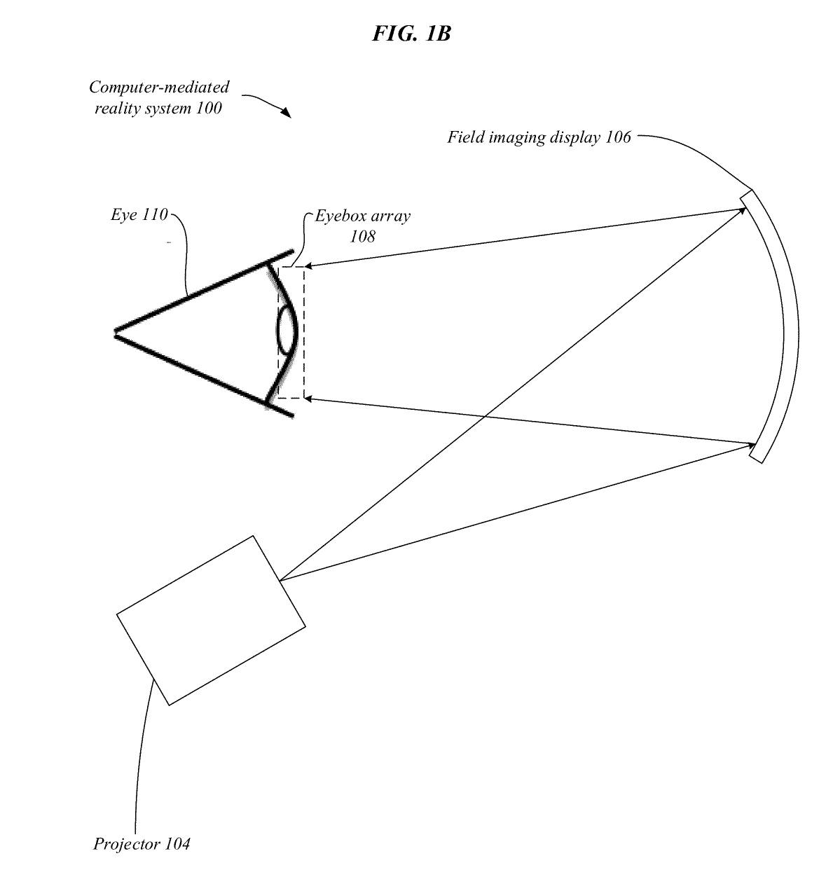

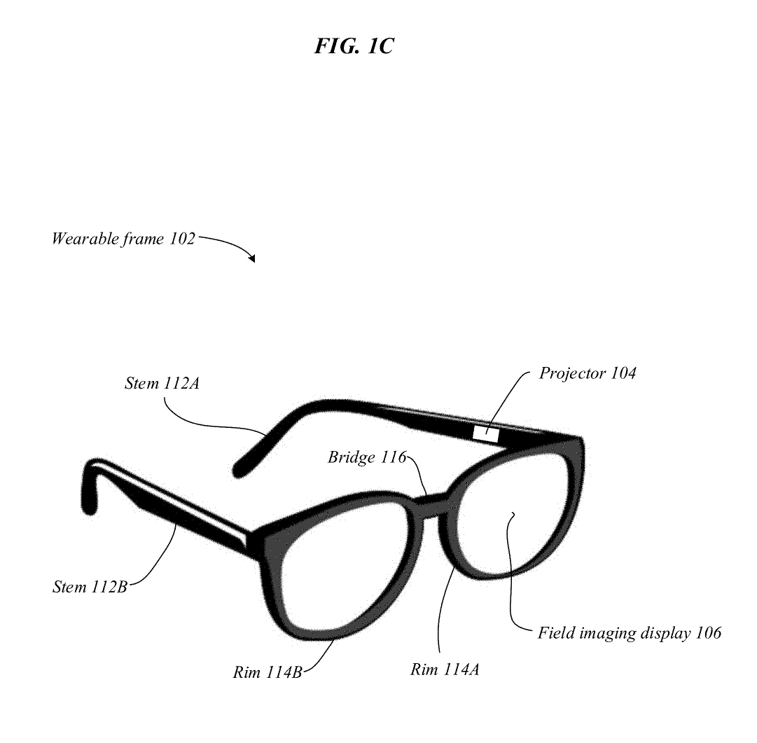

FIG. 1A illustrates an embodiment of a computer-mediated reality system 100. Computer-mediated reality system 100 may include wearable frame 102. Wearable frame 102 may include projector 104 and field imaging display 106. In various embodiments, the components of computer-mediated reality system 100 may operate to provide a user with a computer-mediated reality. For example, computer-mediated reality system 100 may overlay computer generated graphics onto a user's view of the world. Projector 104 may project an image onto field imaging display 106. In some embodiments, the image that projector 104 projects onto the field imaging display 106 may be referred to as the projected image. The field imaging display 106 may reflect the projected image to create eyebox array 108. In some embodiments, the image that field imaging display 106 reflects to create the eyebox array 108 may be referred to as the reflected image. As will be described in more detail below, eyebox array 108 may refer to a range of positions from which a user wearing wearable frame 102 is able to view one or more portions of the reflected image. Embodiments are not limited in this context.

It will be appreciated that the components of computer-mediated reality system 100 in FIG. 1A are exemplary and other components may be used without departing from the scope of this disclosure. For example, computer-mediated reality system 100 may be included in an automobile or an airplane with the field imaging display 106 forming a portion of the windscreen. In another example, one or more components of computer-mediated reality system 100 may be included in a contact lens. In in various embodiments, computer-mediated reality system 100 may include an augmented reality device, such as a head-up display (HUD). In various such embodiments, the HUD may refer to any transparent display that presents data without requiring a user to look away from their usual viewpoints, such as when flying a plane or driving an automobile.

FIG. 1B illustrates an embodiment of computer-mediated reality system 100 in conjunction with an eye 110. In various embodiments, field imaging display 106 may reflect an image projected by projector 104 towards an eye 110 of a user. In various such embodiments, when eye 110 is located within eyebox array 108, one or more portions of the reflected image may be visible to the eye 110. More generally, the predetermined range of positions with respect to field imaging display 106 that enable one or more portions of reflected images to be visible to eye 110 may include or define eyebox array 108, and within each eyebox of eyebox array 108 a specific portion or specific portions of reflected images may be visible to eye 110. In some embodiments, specific portions of a reflected image may become visible as eye 110 shifts between different directions of gaze or lines of sight that intersect with different eyeboxes in eyebox array 108. In some such embodiments, each specific portion of the reflected image may include a duplicate of the same image to enable a user to maintain sight of the same information as they look around. Embodiments are not limited in this context.

FIG. 1C illustrates an embodiment of wearable frame 102. Wearable frame 102 may couple with projector 104 and field imaging display 106. In various embodiments, wearable frame 102 may hold projector 104 in a certain position with respect to field imaging display 106. For example, wearable frame 102 may hold projector 104 at a spacing and angle with respect to field imaging display 106 such that images are appropriately reflected by field imaging display 106 to be viewed by the eye 110 of a user. In some embodiments, wearable frame 102 may position the eye 110 (FIG. 1B) at a spacing with respect to field imaging display 106 such that the eye 110 of a user is appropriately located in eyebox array 108 (FIG. 1B). Embodiments are not limited in this context.

In the illustrated embodiment, wearable frame 102 may include stems 112A, 112B, rims 114A, 114B, and bridge 116. Stem 112A may couple to projector 104 and rim 114A. Rim 114A may couple to field imaging display 106. For example, field imaging display 106 may include a lens held by rim 114A. In some embodiments the lens may be plastic. Rim 114A may be connected to rim 114B by bridge 116. In various embodiments, wearable frame 102 may include any device able to properly position projector 104 with respect to the field imaging display 106 to enable the desired reflection of a projected image by the field imaging display 106. For instance, wearable frame 102 may include one or more of eyeglass frames, a headband, a hat, a mask, a helmet, sunglasses, or similar head worn devices. Further, the number and position of projector 104 and field imaging display 106 may be altered without departing from the scope of this disclosure. For example, wearable frame 102 may include two projectors and two field imaging displays to enable computer-mediated reality for both eyes of a user. As shown in FIG. 1C, in some embodiments, the projector 104 may be embedded in stem 112A of a pair of glasses. In other embodiments, projector 104 may be embedded in rim 114A or bridge 116 of the wearable frame 102.

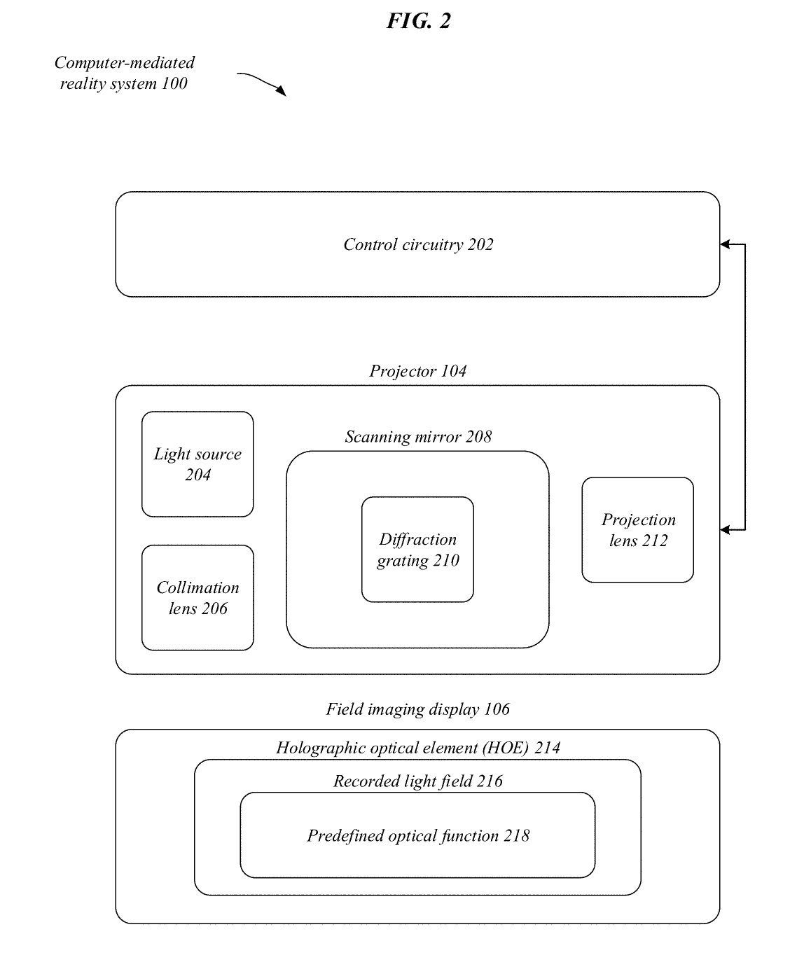

It will be appreciated that the components of wearable frame 102 and their arrangement illustrated in FIG. 1C is exemplary and other components and arrangements may be used without departing from the scope of this disclosure. For example, wearable frame 102 may include control circuitry (e.g., control circuitry 202 (FIG. 2)) and a power source. In some embodiments, the power source may include a battery or similar power storage device and provide operational power to wearable frame 102. Control circuitry may include logic and/or hardware to implement one or more functional aspects of computer-mediated reality system 100. For instance, control circuitry may enable wearable frame 102 to wirelessly communicate with one or more networks.

FIG. 2 illustrates a block diagram of an embodiment of computer-mediated reality system 100. Computer-mediated reality system 100 may include projector 104, field imaging display 106, and control circuitry 202. In various embodiments, one or more of these components may be coupled to wearable frame 102. In various embodiments, the components of computer-mediated reality system 100 may operate to provide a user with a computer-mediated reality. In some embodiments, computer-mediated reality system 100 may provide a user with an augmented view of reality, such as by providing a user with supplemental data regarding a physical object located in the user's FOV. For example, the name of a person in a user's FOV may be overlaid next to the person. Embodiments are not limited in this context.

Control circuitry 202 may enable control and/or operation of one or more components of computer-mediated reality system 100. For example, control circuitry 202 may implement one or more operations or features of computer-mediated reality system 100 described herein. In various embodiments, control circuitry 202 may include one or more of a computer-readable media, a processor, logic, interface elements, a power source, and other hardware and software elements described herein to implement or realize one or more of the operations or features of computer-mediated reality system 100. For instance, control circuitry 202 may include components such as a radio for wireless communication, a speaker, a microphone, a vibration source, a camera, a 3D camera, light imaging, detection, and ranging (LIDAR), and/or a user interface (UI). In embodiments that include a 3D camera or LIDAR, computer-mediated reality system 100 may be able to scan the environment in 3D. In various embodiments, control circuitry 202 may include a computer-readable media and a processor, the computer-readable media to include one or more instructions that when executed by the processor implement an operational aspect of the computer-mediated reality system 100, such as wireless communication with one or more networks. In some embodiments, one or more portions of control circuitry 202 may be included in separate or distinct portions of computer-mediated reality system 100, such as projector 104.

Projector 104 may project one or more images or sequences of images (e.g., video) onto field imaging display 106. In the illustrated embodiment, projector 104 may include a light source 204, a collimation lens 206, a scanning mirror 208, and a projection lens 212. Light source 204 may include one or more of a vertical-cavity surface-emitting laser (VCSEL), an edge emitting laser, a micro light emitting diode (LED), a resonant cavity LED, a quantum dot laser, or the like. In some embodiments, light source 204 may include a plurality of light sources. For instance, light source 204 may include a red light source, a green light source, and a blue light source, also referred to as a RGB light source. For example, light source 204 may include one or more lasers, such as a red laser, a green laser, and a blue laser. A source of red, green, and blue light can enable projector 104 to create full color images. Collimation lens 206 may make a collimated beam from light generated by light source 204. In some embodiments, collimation lens may narrow and/or align the direction of the light generated by light source 204 to make the collimated beam. Scanning mirror 208 may reflect light at various angles onto field imaging display 106 via projection lens 212. In some embodiments, projection lens 212 may correct optical aberrations such as astigmatism, coma, keystone, or the like. In various embodiments, collimation lens 206 and/or projection lens 212 may have an adjustable focal length. For instance, a collimation lens 206 with an adjustable focal length may enable adjustment of the location of eyebox array 108. In some embodiments, projector 104 may not include one or more of collimation lens 206 and projection lens 212.

Light generated by light source 204 may be reflected by scanning mirror 208 to project an image onto field imaging display 106. In various embodiments, scanning mirror 208 may include one or more of a two-axis scanning mirror, a microelectromechanical system (MEMS) scanning mirror, and a three-axis scanning mirror. In some embodiments, scanning mirror 208 may rapidly adjust angle such that light generated by light source 204 is reflected onto field imaging display 106 in a desired manner. For instance, scanning mirror 208 may enable an image to be raster scanned onto field imaging display 106. In various embodiments, MEMS scanning mirror 208 may include a diffraction grating 210. As will be described in more detail below, diffraction grating 210 may enable projector 104 to generate an array of identical sub-images without the need to scan over the whole array of sub-images.

Field imaging display 106 may reflect an image or sequence of images projected by projector 104 toward a user. In the illustrated embodiment, field imaging display 106 may include a holographic optical element (HOE) 214. In some embodiments, HOE 214 may include a reflective transparent hologram. The HOE 214 may include a recorded light field 216. The recorded light field 216 may include a predefined optical function 218. As will be described in more detail below, the predefined optical function 218 may reflect a projected image to create eyebox array 108. In some embodiments, HOE 214 may be one or more of transparent and curved. In various embodiments, HOE 214 may collimate the light it reflects.

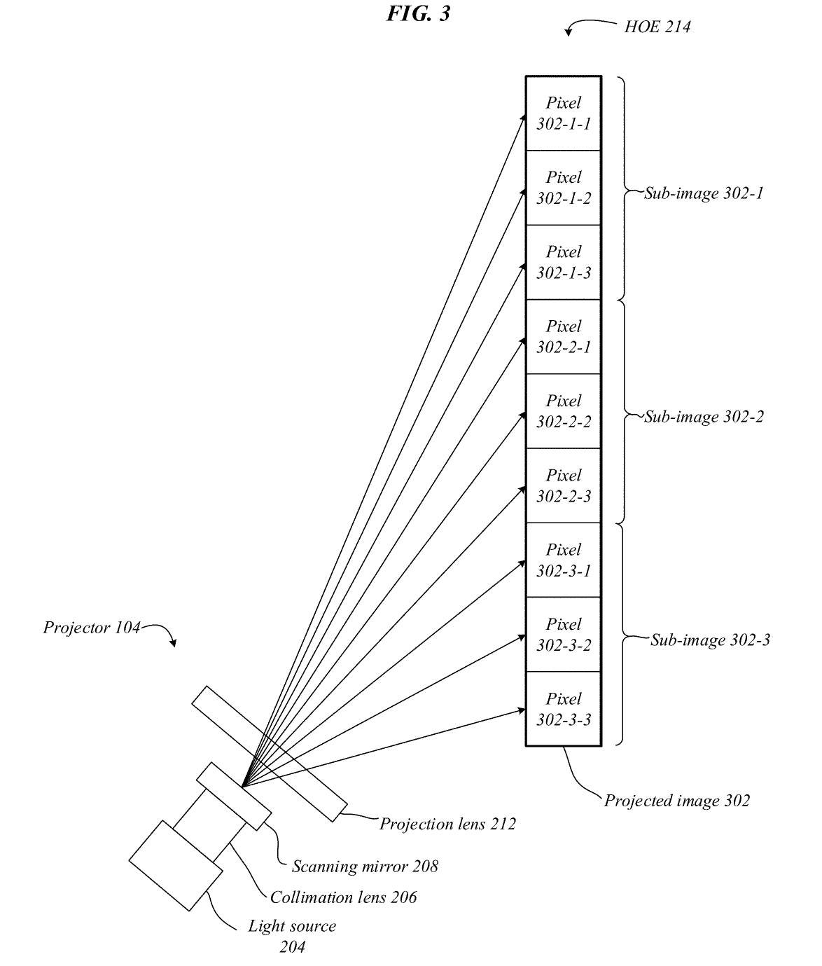

FIG. 3 illustrates an embodiment of projector 104 in conjunction with a projected image 302. As previously described, projector 104 may include light source 204, collimation lens 206, scanning mirror 208, and projection lens 212. Light generated by light source 204 may be collimated by collimation lens 206, resulting in a collimated beam. The scanning mirror 208 may rapidly adjust its orientation to direct the collimated beam onto the HOE 214 via projection lens 212. In various embodiments, collimated beam is no longer collimated after it passes through projection lens 212. As shown in FIG. 3, projected image 302 may include sub-images 302-1, 302-2, 302-3. It will be appreciated that although only a single dimension of projected image 302 is shown for simplicity, projected image 302 may include two or more dimensions. Further, although only three pixels are illustrated for each sub-image 302-1, 302-2, 302-3, each sub-image may include more or less pixels. Embodiments are not limited in this context.

In the illustrated embodiment, each sub-image 302-1, 302-2, 302-3 included in projected image 302 may include the same image of three pixels. In some embodiments, each sub-image may include an identical image or a compensated image, the compensated image to account for an aberration or depth of field difference between different sub-images. In various embodiments, each pixel in each sub-image may be the same or slightly different to account for issues such as aberration compensation or depth of field. Sub-image 302-1 may include pixels 302-1-1, 302-1-2, 302-1-3. Sub-image 302-2 may include pixels 302-2-1, 302-2-2, 302-2-3. Sub-image 302-3 may include pixels 302-3-1, 302-3-2, 302-3-3. In various embodiments, scanning mirror 208 may include diffraction grating 210 (FIG. 2). Diffraction grating 210 may enable projector 104 to generate each of sub-images 302-1, 302-2, 302-3 in an efficient manner, such as by enabling a smaller scanning angle. For instance, diffraction grating 210 may enable scanning mirror 208 to generate the projected image 302 by only scanning over a single sub-image. In some embodiments, this may enable the surface of scanning mirror 208 to be enlarged, leading to a higher resolution projected image.

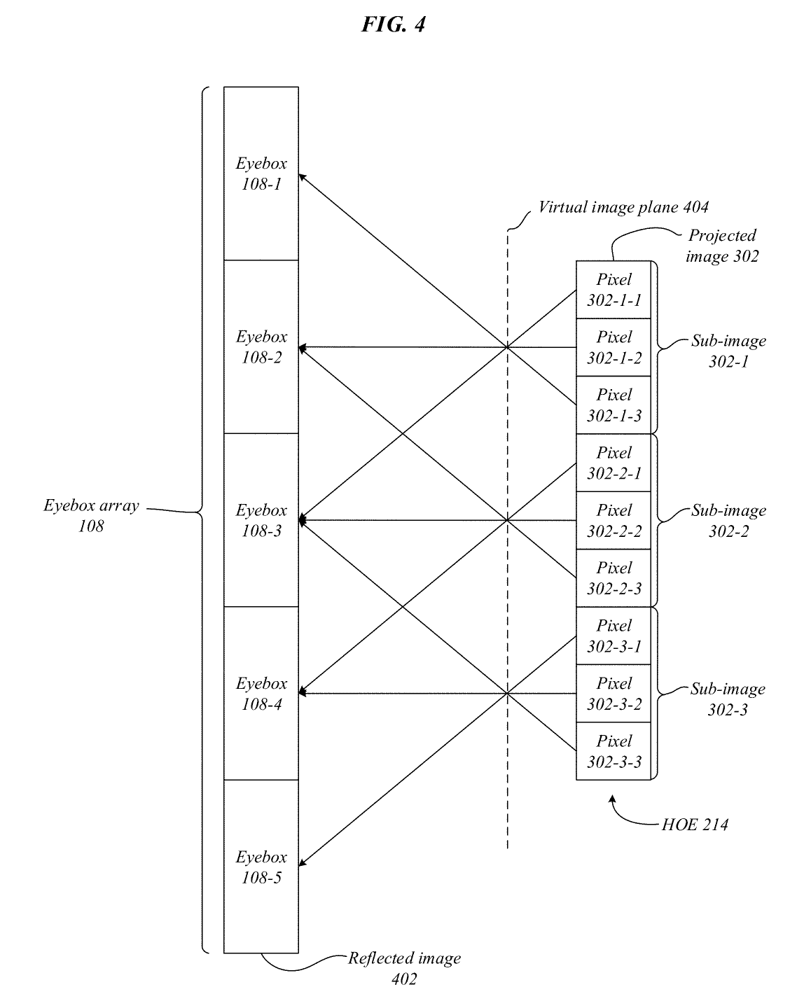

FIG. 4 illustrates an embodiment of a reflected image 402. When an image is projected on HOE 214 a light field recorded in HOE 214 may provide a predefined optical function. In the illustrated embodiment, the predefined optical function reflects each pixel of projected image 302 in a specific manner to create eyebox array 108. For instance, the predefined optical function may create reflected image 402 by reflecting projected image 302 in a manner that reorders the pixels of projected image 302 to create reflected image 402. In various embodiments, virtual image plane 404 may refer to the focal plane of HOE 214. Embodiments are not limited in this context.

Eyebox array 108 may include eyeboxes 108-1, 108-2, 108-3, 180-4, 108-5. In various embodiments, each eyebox may include an eyebox image and, collectively, the eyebox images may be referred to as reflected image 402. In various embodiments, each eyebox image may include the same image as each sub-image, but constructed from pixels from different sub-images per the predefined optical function of the HOE 214. As shown in FIG. 4, the image of eyebox 108-3 may include the first pixel 302-1-1 from sub-image 302-1, the second pixel 302-2-2 from sub-image 302-2, and the third pixel 302-3-3 from sub-image 302-3. It will be appreciated that only sufficient pixels are illustrated for creating the image of eyebox 108-3 for simplicity, however, other eyebox images may be created in the same manner in one or more dimensions. For example, the image of eyebox 180-2 is illustrated as only including two pixels, however, the third pixel would be reflected from an additional sub-image above sub-image 302-1. Accordingly, the number of eyebox images may be proportional to the number of sub-images in projected image 404. For example, the number eyebox images may grow as the number of sub-images grows. Further, the number of pixels in an eyebox image may be proportional to the number of pixels in each sub-image of projected image 404. For example, the number of pixels in an eyebox image may grow as the number of pixels in each sub-image grows.

In some embodiments, the only eyebox image that is visible to a user is the eyebox image included in the eyebox that the user's line of sight or direction of gaze intersects with. In other words, only a subset of the reflected image may be seen by a user at one time, such as one eyebox image, with other eyebox images coming into focus as the direction of gaze changes. In various embodiments, each eyebox image may be the same to enable a user to maintain sight of the same information as they look around. In some embodiments, the predefined optical function of the light field recorded in HOE 214 reflects the projected image 302 in a manner that enables this functionality.

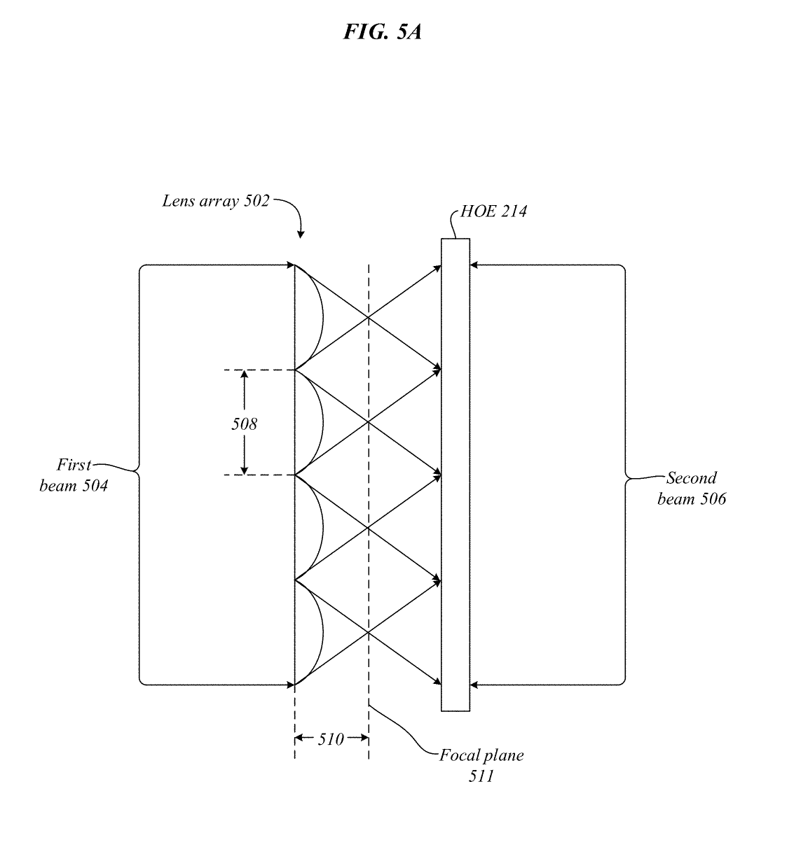

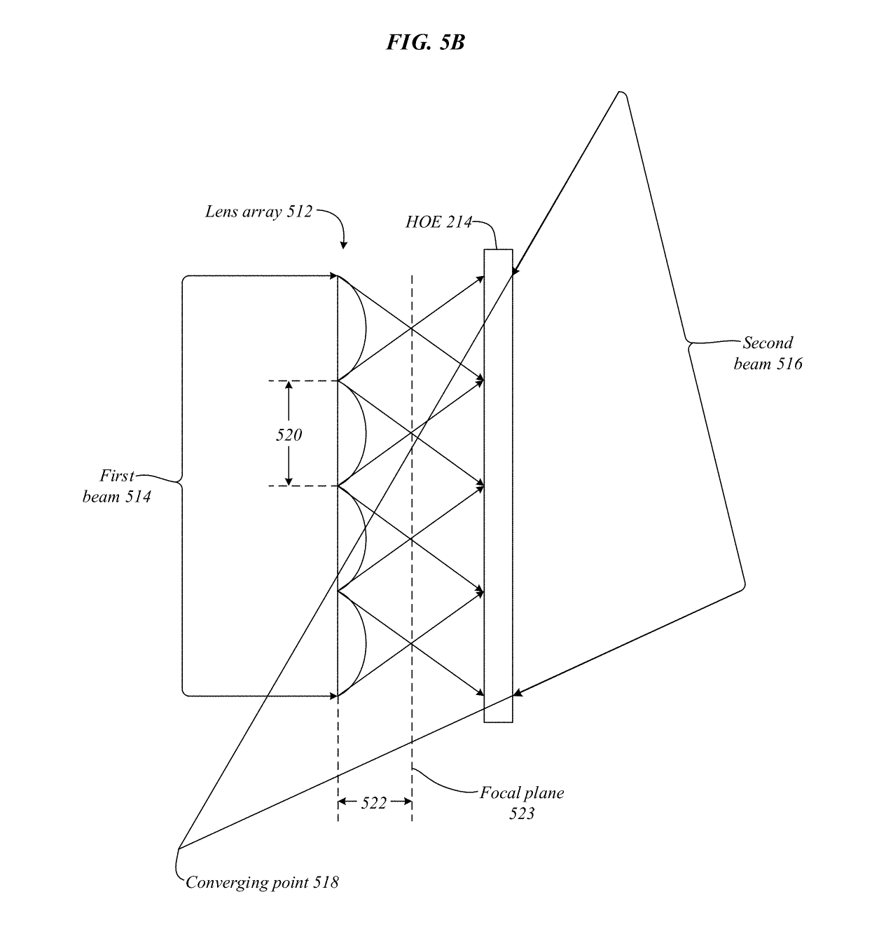

FIGS. 5A-5B illustrate first and second arrangements to record a light field in HOE 214. A recorded light field may be used to provide a predefined optical function. In various embodiments, the optical function of a lens array may be recorded in HOE 214. In other words, the light field of the lens array may be recorded in HOE 214 to give the HOE 214 its predefined optical function. Recording the light field of a lens array in HOE 214 as shown in FIG. 5A may enable HOE 214 to act in the same manner as the lens array would when an image is projected upon it. Recording the light field of a lens array in HOE 214 as shown in FIG. 5B plus the optical function of an off-axis concave mirror may enable HOE 214 to act in the same manner as the lens array would when an image is projected upon it. In various embodiments, the number of eyeboxes in eyebox array 108 (FIG. 4) may be proportional to the number of lenses in the lens array. Embodiments are not limited in this context.

Referring now to FIG. 5A, the first arrangement can include lens array 502, first beam 504, and second beam 506. Element 508 may refer to the diameter of a lens in lens array 502 and element 510 may refer to the focal length of a lens in lens array 502. The arrangement may enable the light field of lens array 502 to be recorded in HOE 214. In some embodiments, the lens array 502 may be positioned in parallel with HOE 214 and separated by a distance that is twice the focal length 510 of each lens in lens array 502. In various embodiments, a focal spot of each lens in lens array 502 may form or define focal plane 511. The first beam 504 may include a beam of collimated light and may be shined onto lens array 502 from the opposite side with respect to HOE 214. The second beam 506 may include a beam of collimated light and may be shined onto HOE 214 from the opposite side with respect to lens array 502. The FOV may be given by two times the arctangent of half of the diameter 508 divided by focal length 510. In some embodiments, various lenses in lens array 502 may have different sizes, different shapes, be aspherical, achromatic, diffractive, or the like. For instance, the lenses in lens array 512 may be square, rectangular, hexagonal, ellipsoidal, or other shapes. Further, the shape of the lens array 512 may change between various embodiments. For example, lens array 512 may be a square array, a hexagonal array, or other shapes.

Referring now to FIG. 5B, the second arrangement can include lens array 512, first beam 514, second beam 516, and converging point 518. Element 520 may refer to the diameter of a lens in lens array 512 and element 522 may refer to the focal length of a lens in lens array 502. The arrangement may enable the light field of lens array 512 to be recorded in HOE 214. In some embodiments, the lens array 512 may be positioned in parallel with HOE 214 and separated by a distance that is twice the focal length 522 of each lens in lens array 512. In various embodiments, a focal spot of each lens in lens array 512 may form or define focal plane 523. The first beam 514 may include a beam of collimated light and may be shined onto lens array 512 from the opposite side with respect to HOE 214. The second beam 516 may include a converging beam of collimated light and may be shined onto HOE 214 from the opposite side with respect to lens array 512. The second beam 516 may be convergent towards HOE 214 and converging to converging point 518. The FOV may be given by two times the arctangent of half of the diameter 520 divided by focal length 522. In some embodiments, various lenses in lens array 512 may have different sizes, different shapes, be aspherical, achromatic, diffractive, or the like. For instance, the lenses in lens array 512 may be square, rectangular, hexagonal, ellipsoid, or other shapes. Further the shape of the lens array 512 may change between various embodiments. For example, lens array 512 may be a square array, a hexagonal array, or other shapes.

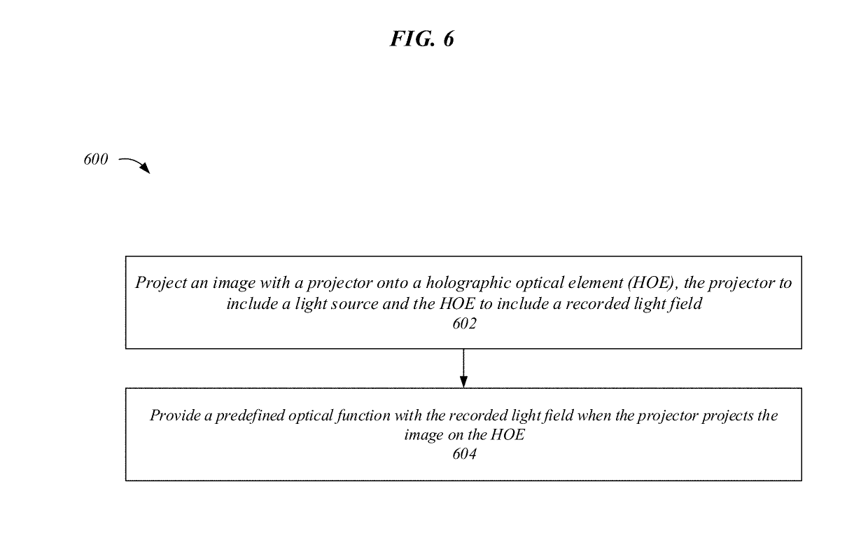

FIG. 6 illustrates one embodiment of a logic flow 600. The logic flow 600 may be representative of some or all of the operations executed by one or more embodiments described here, such as computer-mediated reality system 100. Embodiments are not limited in this context.

In the illustrated embodiment shown in FIG. 6, the logic flow 600 may begin at block 602. At block 602 “project an image with a projector onto a holographic optical element (HOE), the projector to include a light source and the HOE to include a recorded light field” an image may be projected with a projector onto a HOE and the projector may include a light source and the HOE may include a recorded light field. For example, projector 104 may project projected image 302 onto HOE 214 of field imaging display 106. With various embodiments, projector 104 may include one or more of light source 204, collimation lens 206, scanning mirror 208, and projection lens 212. With some embodiments, HOE 214 may include recorded light field 216.

Continuing to block 604 “provide a predefined optical function with the recorded light field when the projector projects the image on the HOE” the light field recorded in the HOE may provide a predefined optical function when the projector projects the image on the HOE. For instance, HOE 214 may create eyebox array 108 via reflection of projected image 302. With various embodiments, HOE 214 may include recorded light field 216, the recorded light field 216 may provide the predefined optical function 218 when projector 104 projects an image onto HOE 214.

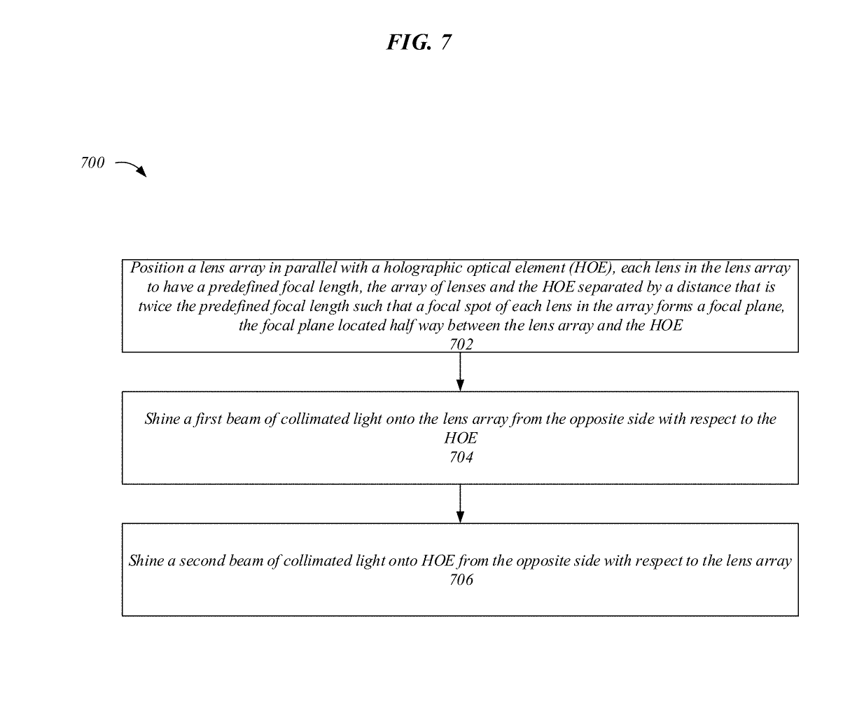

FIG. 7 illustrates one embodiment of a logic flow 700. The logic flow 700 may be representative of some or all of the operations executed by one or more embodiments described herein. Embodiments are not limited in this context.

In the illustrated embodiment shown in FIG. 7, the logic flow 700 may begin at block 702. At block 702 “position a lens array in parallel with a holographic optical element (HOE), each lens in the lens array to have a predefined focal length, the array of lenses and the HOE separated by a distance that is twice the predefined focal length such that a focal spot of each lens in the array forms a focal plane, the focal plane located half way between the lens array and the HOE” a lens array may be positioned in parallel with a HOE and separated by a distance that is twice the predefined focal length with a focal plane located half way between the lens array and the HOE. For example, lens array 512 may be positioned in parallel with HOE 214 and separated by a distance that is twice the focal length 522 of each lens in lens array 512. In various embodiments, a focal spot of each lens in lens array 512 may form or define focal plane 523 and focal plane 523 may be located half way between lens array 512 and HOE 214.

Continuing to block 704 “shine a first beam of collimated light onto the lens array from the opposite side with respect to the HOE” a beam of collimated light may be shined onto the lens array from the opposite side with respect to the HOE. For example, first beam 504 may be shined onto lens array 502 from the opposite side with respect to HOE 214 such that light from the first beam 504 hits HOE 214 after passing through lens array 502. With various embodiments, lens array 502 may refract first beam 504 onto HOE 214.

At block 706 “shine a second beam of collimated light onto HOE from the opposite side with respect to the lens array” a beam of collimated light may be shined onto the HOE from the opposite side with respect to the lens array. For example, second beam 506 may be shined onto HOE 214 from the opposite side with respect to lens array 502 such that light from the second beam 506 hits HOE 214 prior to lens array 502. With various embodiment the second beam of collimated light may be a converging beam, such as second beam 516. With various such embodiments, second beam 516 may have a converging point 518. In some embodiments, converging point 518 is located on the opposite side of lens array 512 with respect to HOE 214.

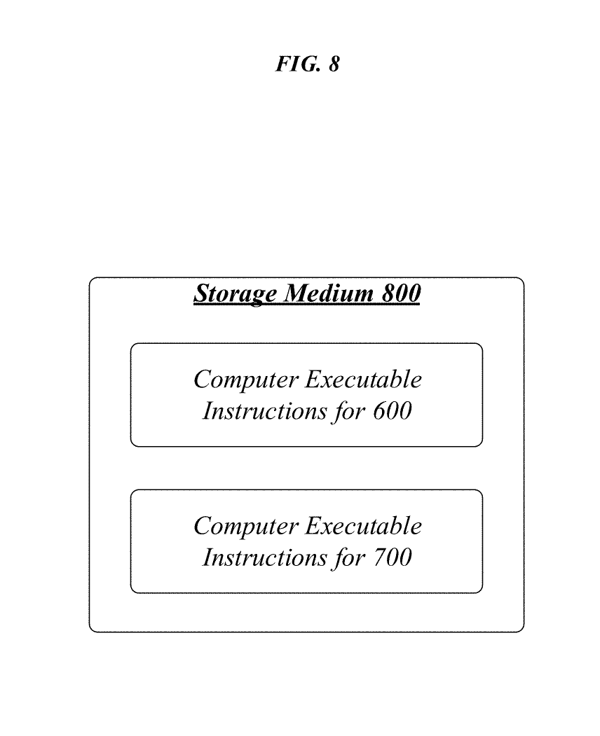

FIG. 8 illustrates an embodiment of a storage medium 800. Storage medium 800 may comprise any non-transitory computer-readable storage medium or machine-readable storage medium, such as an optical, magnetic or semiconductor storage medium. In various embodiments, storage medium 800 may comprise an article of manufacture. In some embodiments, storage medium 800 may store computer-executable instructions, such as computer-executable instructions to implement one or more of logic flows or operations described herein, such as with respect to 700 of FIG. 7. Examples of a computer-readable storage medium or machine-readable storage medium may include any tangible media capable of storing electronic data, including volatile memory or non-volatile memory, removable or non-removable memory, erasable or non-erasable memory, writeable or re-writeable memory, and so forth. Examples of computer-executable instructions may include any suitable type of code, such as source code, compiled code, interpreted code, executable code, static code, dynamic code, object-oriented code, visual code, and the like. The embodiments are not limited in this context.

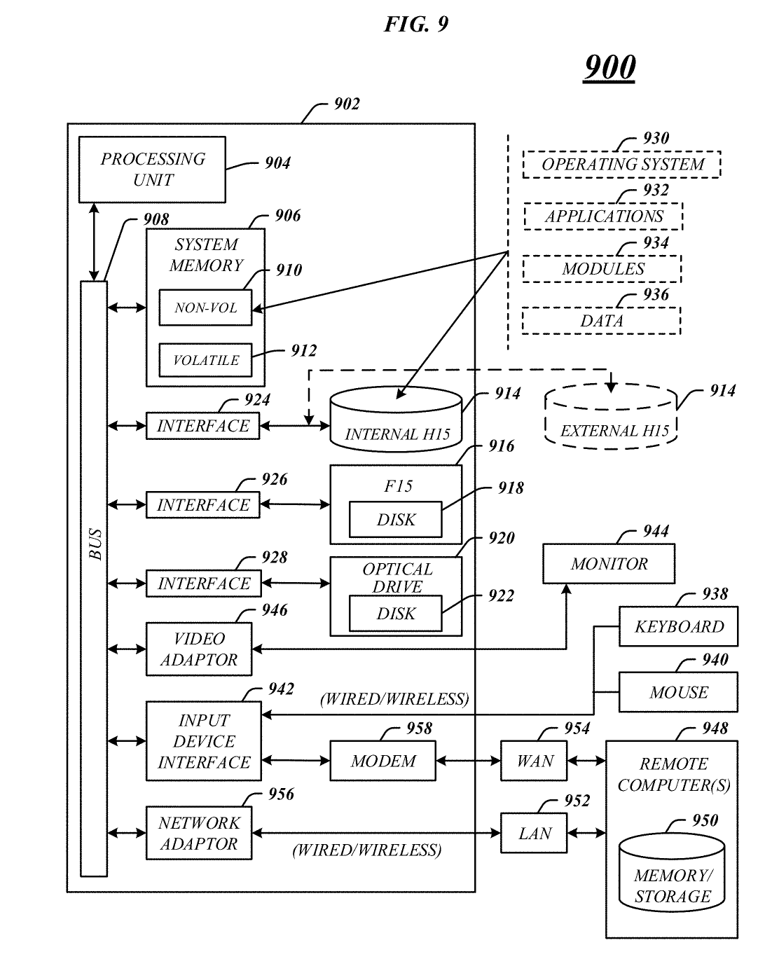

FIG. 9 illustrates an embodiment of an exemplary computing architecture 900 that may be suitable for implementing various embodiments as previously described. In various embodiments, the computing architecture 900 may comprise or be implemented as part of an electronic device. In some embodiments, the computing architecture 900 may be representative, for example, of a processor server that implements one or more components of the computer-mediated reality system 100. In some embodiments, computing architecture 900 may be representative, for example, one or more portions of control circuitry 202 in wearable frame 102 that implements one or more components of computer-mediated reality system 100. The embodiments are not limited in this context.

As used in this application, the terms “system” and “component” and “module” are intended to refer to a computer-related entity, either hardware, a combination of hardware and software, software, or software in execution, examples of which are provided by the exemplary computing architecture 900. For example, a component can be, but is not limited to being, a process running on a processor, a processor, a hard disk drive, multiple storage drives (of optical and/or magnetic storage medium), an object, an executable, a thread of execution, a program, and/or a computer. By way of illustration, both an application running on a server and the server can be a component. One or more components can reside within a process and/or thread of execution, and a component can be localized on one computer and/or distributed between two or more computers. Further, components may be communicatively coupled to each other by various types of communications media to coordinate operations. The coordination may involve the uni-directional or bi-directional exchange of information. For instance, the components may communicate information in the form of signals communicated over the communications media. The information can be implemented as signals allocated to various signal lines. In such allocations, each message is a signal. Further embodiments, however, may alternatively employ data messages. Such data messages may be sent across various connections. Exemplary connections include parallel interfaces, serial interfaces, and bus interfaces.

The computing architecture 900 includes various common computing elements, such as one or more processors, multi-core processors, co-processors, memory units, chipsets, controllers, peripherals, interfaces, oscillators, timing devices, video cards, audio cards, multimedia input/output (I/O) components, power supplies, and so forth. The embodiments, however, are not limited to implementation by the computing architecture 900.

As shown in FIG. 9, the computing architecture 900 comprises a processing unit 904, a system memory 906 and a system bus 908. The processing unit 904 can be any of various commercially available processors, including without limitation an AMD® Athlon®, Duron® and Opteron® processors; ARM® application, embedded and secure processors; IBM® and Motorola® DragonBall® and PowerPC® processors; IBM and Sony® Cell processors; Intel® Celeron®, Core (2) Duo®, Itanium®, Pentium®, Xeon®, and XScale® processors; and similar processors. Dual microprocessors, multi-core processors, and other multi-processor architectures may also be employed as the processing unit 904.

The system bus 908 provides an interface for system components including, but not limited to, the system memory 906 to the processing unit 904. The system bus 908 can be any of several types of bus structure that may further interconnect to a memory bus (with or without a memory controller), a peripheral bus, and a local bus using any of a variety of commercially available bus architectures. Interface adapters may connect to the system bus 908 via a slot architecture. Example slot architectures may include without limitation Accelerated Graphics Port (AGP), Card Bus, (Extended) Industry Standard Architecture ((E)ISA), Micro Channel Architecture (MCA), NuBus, Peripheral Component Interconnect (Extended) (PCI(X)), PCI Express, Personal Computer Memory Card International Association (PCMCIA), and the like.

The system memory 906 may include various types of computer-readable storage media in the form of one or more higher speed memory units, such as read-only memory (ROM), random-access memory (RAM), dynamic RAM (DRAM), Double-Data-Rate DRAM (DDRAM), synchronous DRAM (SDRAM), static RAM (SRAM), programmable ROM (PROM), erasable programmable ROM (EPROM), electrically erasable programmable ROM (EEPROM), flash memory (e.g., one or more flash arrays), polymer memory such as ferroelectric polymer memory, ovonic memory, phase change or ferroelectric memory, silicon-oxide-nitride-oxide-silicon (SONOS) memory, magnetic or optical cards, an array of devices such as Redundant Array of Independent Disks (RAID) drives, solid state memory devices (e.g., USB memory, solid state drives (SSD) and any other type of storage media suitable for storing information. In the illustrated embodiment shown in FIG. 9, the system memory 906 can include non-volatile memory 910 and/or volatile memory 912. A basic input/output system (BIOS) can be stored in the non-volatile memory 910.

The computer 902 may include various types of computer-readable storage media in the form of one or more lower speed memory units, including an internal (or external) hard disk drive (HDD) 914, a magnetic floppy disk drive (FDD) 916 to read from or write to a removable magnetic disk 918, and an optical disk drive 920 to read from or write to a removable optical disk 922 (e.g., a CD-ROM or DVD). The HDD 914, FDD 916 and optical disk drive 920 can be connected to the system bus 908 by a HDD interface 924, an FDD interface 926 and an optical drive interface 928, respectively. The HDD interface 924 for external drive implementations can include at least one or both of Universal Serial Bus (USB) and IEEE 994 interface technologies.

The drives and associated computer-readable media provide volatile and/or nonvolatile storage of data, data structures, computer-executable instructions, and so forth. For example, a number of program modules can be stored in the drives and memory units 910, 912, including an operating system 930, one or more application programs 932, other program modules 934, and program data 936. In one embodiment, the one or more application programs 932, other program modules 934, and program data 936 can include, for example, the various applications and/or components of the computer-mediated reality system 100.

A user can enter commands and information into the computer 902 through one or more wire/wireless input devices, for example, a keyboard 938 and a pointing device, such as a mouse 940. Other input devices may include microphones, infra-red (IR) remote controls, radio-frequency (RF) remote controls, game pads, stylus pens, card readers, dongles, finger print readers, gloves, graphics tablets, joysticks, keyboards, retina readers, touch screens (e.g., capacitive, resistive, etc.), trackballs, trackpads, sensors, styluses, and the like. These and other input devices are often connected to the processing unit 904 through an input device interface 942 that is coupled to the system bus 908, but can be connected by other interfaces such as a parallel port, IEEE 994 serial port, a game port, a USB port, an IR interface, and so forth.

A monitor 944 or other type of display device is also connected to the system bus 908 via an interface, such as a video adaptor 946. The monitor 944 may be internal or external to the computer 902. In addition to the monitor 944, a computer typically includes other peripheral output devices, such as speakers, printers, and so forth.

The computer 902 may operate in a networked environment using logical connections via wire and/or wireless communications to one or more remote computers, such as a remote computer 948. The remote computer 948 can be a workstation, a server computer, a router, a personal computer, portable computer, microprocessor-based entertainment appliance, a peer device or other common network node, and typically includes many or all of the elements described relative to the computer 902, although, for purposes of brevity, only a memory/storage device 950 is illustrated. The logical connections depicted include wire/wireless connectivity to a local area network (LAN) 952 and/or larger networks, for example, a wide area network (WAN) 954. Such LAN and WAN networking environments are commonplace in offices and companies, and facilitate enterprise-wide computer networks, such as intranets, all of which may connect to a global communications network, for example, the Internet.

When used in a LAN networking environment, the computer 902 is connected to the LAN 952 through a wire and/or wireless communication network interface or adaptor 956. The adaptor 956 can facilitate wire and/or wireless communications to the LAN 952, which may also include a wireless access point disposed thereon for communicating with the wireless functionality of the adaptor 956.

When used in a WAN networking environment, the computer 902 can include a modem 958, or is connected to a communications server on the WAN 954, or has other means for establishing communications over the WAN 954, such as by way of the Internet. The modem 958, which can be internal or external and a wire and/or wireless device, connects to the system bus 908 via the input device interface 942. In a networked environment, program modules depicted relative to the computer 902, or portions thereof, can be stored in the remote memory/storage device 950. It will be appreciated that the network connections shown are exemplary and other means of establishing a communications link between the computers can be used.

The computer 902 is operable to communicate with wire and wireless devices or entities using the IEEE 802 family of standards, such as wireless devices operatively disposed in wireless communication (e.g., IEEE 802.16 over-the-air modulation techniques). This includes at least Wi-Fi (or Wireless Fidelity), WiMax, and Bluetooth™ wireless technologies, among others. Thus, the communication can be a predefined structure as with a conventional network or simply an ad hoc communication between at least two devices. Wi-Fi networks use radio technologies called IEEE 802.11x (a, b, g, n, etc.) to provide secure, reliable, fast wireless connectivity. A Wi-Fi network can be used to connect computers to each other, to the Internet, and to wire networks (which use IEEE 802.3-related media and functions).

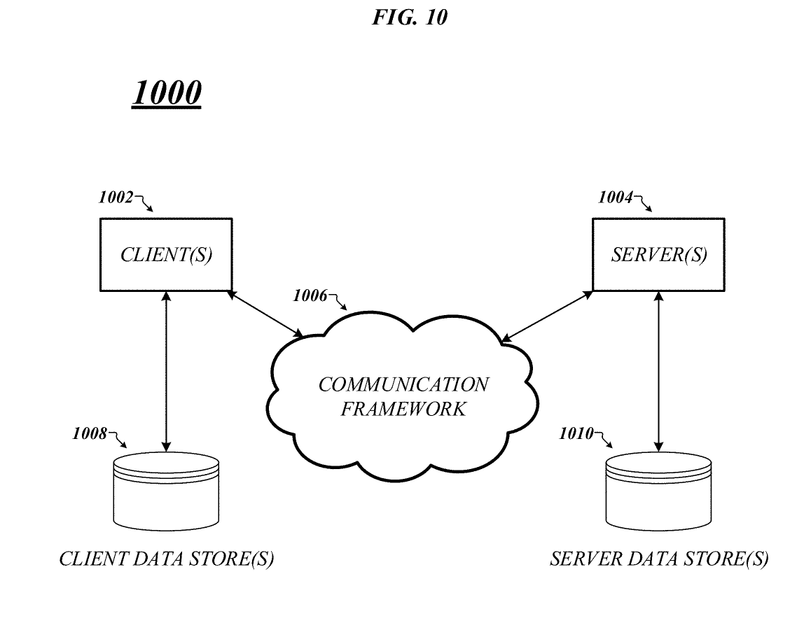

FIG. 10 illustrates a block diagram of an exemplary communication architecture 1000 suitable for implementing various embodiments as previously described. The communication architecture 1000 includes various common communications elements, such as a transmitter, receiver, transceiver, radio, network interface, baseband processor, antenna, amplifiers, filters, power supplies, and so forth. The embodiments, however, are not limited to implementation by the communication architecture 1000.

As shown in FIG. 10, the communication architecture 1000 comprises includes one or more clients 1002 and servers 1004. The clients 1002 and the servers 1004 are operatively connected to one or more respective client data stores 1008 and server data stores 1010 that can be employed to store information local to the respective clients 1002 and servers 1004, such as cookies and/or associated contextual information. In various embodiments, any one of servers 1004 may implement one or more of logic flows or operations described herein, and storage medium 800 of FIG. 8 in conjunction with storage of data received from any one of clients 1002 on any of server data stores 1010.

The clients 1002 and the servers 1004 may communicate information between each other using a communication framework 1006. The communications framework 1006 may implement any well-known communications techniques and protocols. The communications framework 1006 may be implemented as a packet-switched network (e.g., public networks such as the Internet, private networks such as an enterprise intranet, and so forth), a circuit-switched network (e.g., the public switched telephone network), or a combination of a packet-switched network and a circuit-switched network (with suitable gateways and translators).

The communications framework 1006 may implement various network interfaces arranged to accept, communicate, and connect to a communications network. A network interface may be regarded as a specialized form of an input output interface. Network interfaces may employ connection protocols including without limitation direct connect, Ethernet (e.g., thick, thin, twisted pair 10/100/1900 Base T, and the like), token ring, wireless network interfaces, cellular network interfaces, IEEE 802.11a-x network interfaces, IEEE 802.16 network interfaces, IEEE 802.20 network interfaces, and the like. Further, multiple network interfaces may be used to engage with various communications network types. For example, multiple network interfaces may be employed to allow for the communication over broadcast, multicast, and unicast networks. Should processing requirements dictate a greater amount speed and capacity, distributed network controller architectures may similarly be employed to pool, load balance, and otherwise increase the communicative bandwidth required by clients 1002 and the servers 1004. A communications network may be any one and the combination of wired and/or wireless networks including without limitation a direct interconnection, a secured custom connection, a private network (e.g., an enterprise intranet), a public network (e.g., the Internet), a Personal Area Network (PAN), a Local Area Network (LAN), a Metropolitan Area Network (MAN), an Operating Missions as Nodes on the Internet (OMNI), a Wide Area Network (WAN), a wireless network, a cellular network, and other communications networks.

Various embodiments may be implemented using hardware elements, software elements, or a combination of both. Examples of hardware elements may include processors, microprocessors, circuits, circuit elements (e.g., transistors, resistors, capacitors, inductors, and so forth), integrated circuits, application specific integrated circuits (ASIC), programmable logic devices (PLD), digital signal processors (DSP), field programmable gate array (FPGA), logic gates, registers, semiconductor device, chips, microchips, chip sets, and so forth. Examples of software may include software components, programs, applications, computer programs, application programs, system programs, machine programs, operating system software, middleware, firmware, software modules, routines, subroutines, functions, methods, procedures, software interfaces, application program interfaces (API), instruction sets, computing code, computer code, code segments, computer code segments, words, values, symbols, or any combination thereof. Determining whether an embodiment is implemented using hardware elements and/or software elements may vary in accordance with any number of factors, such as desired computational rate, power levels, heat tolerances, processing cycle budget, input data rates, output data rates, memory resources, data bus speeds and other design or performance constraints.

One or more aspects of at least one embodiment may be implemented by representative instructions stored on a machine-readable medium which represents various logic within the processor, which when read by a machine causes the machine to fabricate logic to perform the techniques described herein. Such representations, known as “IP cores” may be stored on a tangible, machine readable medium and supplied to various customers or manufacturing facilities to load into the fabrication machines that actually make the logic or processor. Some embodiments may be implemented, for example, using a machine-readable medium or article which may store an instruction or a set of instructions that, if executed by a machine, may cause the machine to perform a method and/or operations in accordance with the embodiments. Such a machine may include, for example, any suitable processing platform, computing platform, computing device, processing device, computing system, processing system, computer, processor, or the like, and may be implemented using any suitable combination of hardware and/or software. The machine-readable medium or article may include, for example, any suitable type of memory unit, memory device, memory article, memory medium, storage device, storage article, storage medium and/or storage unit, for example, memory, removable or non-removable media, erasable or non-erasable media, writeable or re-writeable media, digital or analog media, hard disk, floppy disk, Compact Disk Read Only Memory (CD-ROM), Compact Disk Recordable (CD-R), Compact Disk Rewriteable (CD-RW), optical disk, magnetic media, magneto-optical media, removable memory cards or disks, various types of Digital Versatile Disk (DVD), a tape, a cassette, or the like. The instructions may include any suitable type of code, such as source code, compiled code, interpreted code, executable code, static code, dynamic code, encrypted code, and the like, implemented using any suitable high-level, low-level, object-oriented, visual, compiled and/or interpreted programming language.

The following examples pertain to further embodiments, from which numerous permutations and configurations will be apparent.

Example 1 is an apparatus to generate an eyebox array for computer-mediated reality, the apparatus comprising: a projector to project an image; and a field imaging display comprising a holographic optical element (HOE), the HOE comprising a recorded light field to direct the projected image to a plurality of eyeboxes.

Example 2 includes the subject matter of Example 1, the HOE to direct the projected image to the plurality of eyeboxes to reorder a plurality of pixels in the projected image.

Example 3 includes the subject matter of Example 1, the projected image to include a plurality of sub-images, each sub-image to include a set of pixels.

Example 4 includes the subject matter of Example 3, the recorded light field to reflect the plurality of sub-images to direct the projected image to the plurality of eyeboxes.

Example 5 includes the subject matter of Example 4, the recorded light field to direct a pixel in each of at least two sets of pixels that correspond to at least two sub-images of the plurality of sub-images to each of the plurality of eyeboxes.

Example 6 includes the subject matter of Example 5, each of the plurality of sub-images to include an identical image or a compensated image, the compensated image to account for an aberration or depth of field different between different sub-images.

Example 7 is an apparatus to generate an eyebox array for computer-mediated reality, the apparatus comprising: a projector to project an image; and a field imaging display with a holographic optical element (HOE), the HOE to include a recorded light field, the recorded light field to provide a predefined optical function in response to projection of the image on the HOE.

Example 8 includes the subject matter of Example 7, comprising a wearable frame, the wearable frame coupled to the projector and the field imaging display.

Example 9 includes the subject matter of Example 7, the predefined optical function to create an eyebox array via reflection of the projected image.

Example 10 includes the subject matter of Example 7, the predefined optical function to reflect the projected image, the projected image to include a plurality of sub-images, each of the sub-images to include a plurality of pixels.

Example 11 includes the subject matter of Example 10, reflection of the projected image to form an eyebox array, the eyebox array to include a plurality of eyeboxes, each of the plurality of eyeboxes to include an eyebox image, each of the eyebox images to include at least one pixel from at least two of the plurality of sub-images.

Example 12 includes the subject matter of Example 10, each of the plurality of sub-images to include an identical image or a compensated image, the compensated image to account for an aberration or depth of field difference between different sub-images.

Example 13 includes the subject matter of Example 7, the projector to raster scan the projected image onto the HOE.

Example 14 includes the subject matter of Example 7, the HOE comprising a transparent volume hologram.

Example 15 includes the subject matter of Example 7, the HOE comprising a curved HOE.

Example 16 includes the subject matter of Example 7, the HOE comprising a reflective volume hologram.

Example 17 includes the subject matter of Example 7, the projector comprising a two-axis scanning mirror.

Example 18 includes the subject matter of Example 17, the two-axis scanning mirror to include a microelectromechanical system (MEMS) scanning mirror.

Example 19 includes the subject matter of Example 17, the two-axis scanning mirror to include a diffraction grating, the diffraction grating to generate a plurality of sub-images in the projected image.

Example 20 includes the subject matter of Example 19, the two-axis scanning mirror to generate the projected image by raster scanning one of the plurality of sub-images.

Example 21 includes the subject matter of Example 7, the recorded light field to include a light field of a lens or an array of lenses.

Example 22 includes the subject matter of Example 7, the recorded light field to include a light field of combining optics for the field imaging display.

Example 23 includes the subject matter of Example 7, the projector to include a light source, the light source to include a red light source, and green light source, and a blue light source.

Example 24 includes the subject matter of Example 7, the projector to include a light source, the light source to include one or more of a vertical-cavity surface-emitting laser (VCSEL), an edge emitting laser, a micro light emitting diode (LED), a resonant cavity LED, and a quantum dot laser.

Example 25 includes the subject matter of Example 7, the projector to include a lens to collimate light from the light source.

Example 26 is a method to generate an eyebox array for computer-mediated reality, the method comprising: projecting an image with a projector onto a holographic optical element (HOE), the projector including a light source and the HOE including a recorded light field; and providing a predefined optical function with the recorded light field in response to projection of the image on the HOE.

Example 27 includes the subject matter of Example 26, the predefined optical function comprising creating an eyebox array via reflection of the projected image.

Example 28 includes the subject matter of Example 26, the predefined optical function comprising reflecting the projected image, the projected image including a plurality of sub-images, each of the sub-images including a plurality of pixels.

Example 29 includes the subject matter of Example 28, each of the plurality of sub-images including an identical image or a compensated image, the compensated image accounting for an aberration or depth of field difference between different sub-images.

Example 30 includes the subject matter of Example 26, comprising raster scanning the projected image onto the HOE.

Example 31 includes the subject matter of Example 26, the projector comprising a scanning mirror.

Example 32 includes the subject matter of Example 31, comprising generating a plurality of sub-images in the projected image with the scanning mirror.

Example 33 includes the subject matter of Example 32, the scanning mirror comprising a diffraction grating.

Example 34 includes the subject matter of Example 33, comprising generating the plurality of sub-images in the projected image by raster scanning one of the plurality of sub-images with the scanning mirror.

Example 35 includes the subject matter of Example 26, the projector comprising a light source and a lens.

Example 36 includes the subject matter of Example 35, comprising collimating light from the light source with the lens.

Example 37 is a system to generate an eyebox array for computer-mediated reality, the system comprising: a projector to project an image, the projector to include a light source; a field imaging display with a holographic optical element (HOE), the HOE to include a recorded light field, the recorded light field to provide a predefined optical function in response to projection of the image on the HOE; and a wearable frame to couple with the projector and the field imaging display and to hold the projector in a certain position with respect to the field imaging display.

Example 38 includes the subject matter of Example 37, the wearable frame comprising an eye glass frame.

Example 39 includes the subject matter of Example 37, the predefined optical function to create an eyebox array via reflection of the projected image.

Example 40 includes the subject matter of Example 37, the predefined optical function to reflect the projected image, the projected image to include a plurality of sub-images, each of the sub-images to include a plurality of pixels.

Example 41 includes the subject matter of Example 40, reflection of the projected image to form an eyebox array, the eyebox array to include a plurality of eyeboxes, each of the plurality of eyeboxes to include an eyebox image, each of the eyebox images to include at least one pixel from at least two of the plurality of sub-images.

Example 42 includes the subject matter of Example 40, each of the plurality of sub-images to include an identical image or a compensated image, the compensated image to account for an aberration or depth of field difference between different sub-images.

Example 43 includes the subject matter of Example 37, the projector to raster scan the projected image onto the HOE.

Example 44 includes the subject matter of Example 37, the HOE comprising a transparent volume hologram.

Example 45 includes the subject matter of Example 37, the HOE comprising a curved HOE.

Example 46 includes the subject matter of Example 37, the HOE comprising a reflective volume hologram.

Example 47 includes the subject matter of Example 37, the projector comprising a two-axis scanning mirror.

Example 48 includes the subject matter of Example 47, the two-axis scanning mirror to include a microelectromechanical system (MEMS) scanning mirror.

Example 49 includes the subject matter of Example 47, the two-axis scanning mirror to include a diffraction grating, the diffraction grating to generate a plurality of sub-images in the projected image.

Example 50 includes the subject matter of Example 49, the two-axis scanning mirror to generate the projected image by raster scanning one of the plurality of sub-images.

Example 51 includes the subject matter of Example 37, the recorded light field to include a light field of a lens or an array of lenses.

Example 52 includes the subject matter of Example 37, the recorded light field to include a light field of combining optics for the field imaging display.

Example 53 includes the subject matter of Example 37, the projector to include a light source, the light source to include a red light source, and green light source, and a blue light source.

Example 54 includes the subject matter of Example 37, the projector to include a light source, the light source to include one or more of a vertical-cavity surface-emitting laser (VCSEL), an edge emitting laser, a micro light emitting diode (LED), a resonant cavity LED, and a quantum dot laser.

Example 55 includes the subject matter of Example 37, the projector to include a lens to collimate light from the light source.

Example 56 is an apparatus to generate an eyebox array for computer-mediated reality, the apparatus comprising: a projection means to project an image, the projector to include a light source; and a field imaging display means, the field imaging display means to include a recorded light field, the recorded light field to provide a predefined optical function in response to projection of the image on the field imaging display means.

Example 57 includes the subject matter of Example 56, comprising a wearable frame, the wearable frame coupled to the projector means and the field imaging display means.

Example 58 includes the subject matter of Example 56, the predefined optical function to create an eyebox array via reflection of the projected image.

Example 59 includes the subject matter of Example 56, the predefined optical function to reflect the projected image, the projected image to include a plurality of sub-images, each of the sub-images to include a plurality of pixels.

Example 60 includes the subject matter of Example 59, reflection of the projected image to form an eyebox array, the eyebox array to include a plurality of eyeboxes, each of the plurality of eyeboxes to include an eyebox image, each of the eyebox images to include at least one pixel from at least two of the plurality of sub-images.

Example 61 includes the subject matter of Example 59, each of the plurality of sub-images to include an identical image or a compensated image, the compensated image to account for an aberration or depth of field difference between different sub-images.

Example 62 includes the subject matter of Example 56, the projection means to raster scan the projected image onto the HOE.

Example 63 includes the subject matter of Example 56, the HOE comprising a transparent volume hologram.

Example 64 includes the subject matter of Example 56, the HOE comprising a curved HOE.

Example 65 includes the subject matter of Example 56, the HOE comprising a reflective volume hologram.

Example 66 includes the subject matter of Example 56, the projection means comprising a two-axis scanning mirror.

Example 67 includes the subject matter of Example 66, the two-axis scanning mirror to include a microelectromechanical system (MEMS) scanning mirror.

Example 68 includes the subject matter of Example 66, the two-axis scanning mirror to include a diffraction grating, the diffraction grating to generate a plurality of sub-images in the projected image.

Example 69 includes the subject matter of Example 68, the two-axis scanning mirror to generate the projected image by raster scanning one of the plurality of sub-images.

Example 70 includes the subject matter of Example 56, the recorded light field to include a light field of a lens or an array of lenses.

Example 71 includes the subject matter of Example 56, the recorded light field to include a light field of combining optics for the field imaging display means.

Example 72 includes the subject matter of Example 56, the projection means to include a light source, the light source to include a red light source, and green light source, and a blue light source.

Example 73 includes the subject matter of Example 56, the projection means to include a light source, the light source to include one or more of a vertical-cavity surface-emitting laser (VCSEL), an edge emitting laser, a micro light emitting diode (LED), a resonant cavity LED, and a quantum dot laser.

Example 74 includes the subject matter of Example 56, the projection means to include a lens to collimate light from the light source.

Example 75 is one or more computer-readable media to store instructions that when executed by a processor circuit causes the processor circuit to project an image with a projector onto a holographic optical element (HOE) included in a field imaging display, the projector including a light source and a microelectromechanical system (MEMS) scanning mirror and the HOE including a recorded light field that provides a predefined optical function.

Example 76 includes the subject matter of Example 75, with instructions to raster scan the projected image onto the HOE.

Example 77 includes the subject matter of Example 75, with instructions to raster scan one of a plurality of sub-images in the projected image to generate the projected image.

Example 78 is a method to record a light field in a field imaging display, the method comprising: positioning an lens array in parallel with a holographic optical element (HOE), each lens in the lens array having a predefined focal length, the array of lenses and the HOE separated by a distance that is twice the predefined focal length and a focal spot of each lens in the array forms a focal plane, the focal plane located half way between the lens array and the HOE; shining a first beam of collimated light onto the lens array from the opposite side with respect to the HOE; and shining a second beam of collimated light onto the HOE from the opposite side with respect to the lens array.

Example 79 includes the subject matter of Example 78, the lens array including one or more lenses of different sizes or shapes.

Example 80 includes the subject matter of Example 78, the lens array including one or more lenses with one or more aspherical, achromatic, and diffractive properties.

Example 81 includes the subject matter of Example 78, the second beam comprising a converging beam.

Example 82 includes the subject matter of Example 78, one or more of the first and second beams positioned perpendicular with respect to the focal plane.

Example 83 includes the subject matter of Example 78, one or more of the first and second beams positioned non-perpendicular with respect to the focal plane.

Example 84 includes the subject matter of Example 83, the one or more of the first and second beams positioned non-perpendicular with respect to the focal plane comprising a converging beam.

Example 85 includes the subject matter of Example 78, one of the first and second beams positioned perpendicular with respect to the focal plane and the other of the first and second beams positioned non-perpendicular with respect to the focal plane.

The foregoing description of example embodiments has been presented for the purposes of illustration and description. It is not intended to be exhaustive or to limit the present disclosure to the precise forms disclosed. Many modifications and variations are possible in light of this disclosure. It is intended that the scope of the present disclosure be limited not by this detailed description, but rather by the claims appended hereto. Future filed applications claiming priority to this application may claim the disclosed subject matter in a different manner, and may generally include any set of one or more limitations as variously disclosed or otherwise demonstrated herein.

1. An apparatus, comprising:
a projector to project an image; and
a field imaging display comprising a holographic optical element (HOE), the HOE comprising a recorded light field to direct the projected image to a plurality of eyeboxes.

2. The apparatus of claim 1, the HOE to direct the projected image to the plurality of eyeboxes to reorder a plurality of pixels in the projected image.

3. The apparatus of claim 1, the projected image to include a plurality of sub-images, each sub-image to include a set of pixels.

4. The apparatus of claim 3, the recorded light field to reflect the plurality of sub-images to direct the projected image to the plurality of eyeboxes.

5. The apparatus of claim 4, the recorded light field to direct a pixel in each of at least two sets of pixels that correspond to at least two sub-images of the plurality of sub-images to each of the plurality of eyeboxes.

6. The apparatus of claim 5, each of the plurality of sub-images to include an identical image or a compensated image, the compensated image to account for an aberration or depth of field different between different sub-images.

7. A system to project an image, comprising:
a projector to project an image, the projector to include a light source;
a field imaging display with a holographic optical element (HOE), the HOE to include a recorded light field, the recorded light field to provide a predefined optical function in response to projection of the image on the HOE; and
a wearable frame to couple with the projector and the field imaging display and to hold the projector in a certain position with respect to the field imaging display.

8. The system of claim 7, the wearable frame comprising an eye glass frame.

9. The system of claim 7, the predefined optical function to create an eyebox array via reflection of the projected image.

10. The system of claim 7, the predefined optical function to reflect the projected image, the projected image to include a plurality of sub-images, each of the sub-images to include a plurality of pixels.

11. The system of claim 10, reflection of the projected image to form an eyebox array, the eyebox array to include a plurality of eyeboxes, each of the plurality of eyeboxes to include an eyebox image, each of the eyebox images to include at least one pixel from at least two of the plurality of sub-images.

12. The system of claim 10, each of the plurality of sub-images to include an identical image or a compensated image, the compensated image to account for an aberration or depth of field difference between different sub-images.

13. The system of claim 7, the projector to raster scan the projected image onto the HOE.

14. The system of claim 7, the HOE comprising one or more of a transparent volume hologram, a curved HOE, and a reflective volume hologram.

15. The system of claim 7, the projector comprising a two-axis scanning mirror.

16. The system of claim 15, the two-axis scanning mirror to include a microelectromechanical system (MEMS) scanning mirror.

17. The system of claim 15, the two-axis scanning mirror to include a diffraction grating, the diffraction grating to generate a plurality of sub-images in the projected image.

18. The system of claim 17, the two-axis scanning mirror to generate the projected image by raster scanning one of the plurality of sub-images.

19. The system of claim 7, the recorded light field to include one or more of a light field of a lens, a lens array, and combining optics for the field imaging display.

20. A method of recording a light field, comprising:
positioning an lens array in parallel with a holographic optical element (HOE), each lens in the lens array having a predefined focal length, the array of lenses and the HOE separated by a distance that is twice the predefined focal length and a focal spot of each lens in the array forms a focal plane, the focal plane located half way between the lens array and the HOE;
shining a first beam of collimated light onto the lens array from the opposite side with respect to the HOE; and
shining a second beam of collimated light onto the HOE from the opposite side with respect to the lens array.

21. The method of claim 20, the lens array including one or more lenses of different sizes or shapes.

22. The method of claim 20, the lens array including one or more lenses with one or more aspherical, achromatic, and diffractive properties.

23. The method of claim 20, one or more of the first and second beams positioned perpendicular with respect to the focal plane.

24. The method of claim 20, one or more of the first and second beams positioned non-perpendicular with respect to the focal plane.

25. The method of claim 24, the one or more of the first and second beams positioned non-perpendicular with respect to the focal plane comprising a converging beam.
